(19) United States
(12) Patent Application Publication
(10) Pub. No.: US 2004/0087430 A1
(43) Pub. Date: May 6, 2004

(54) Refractory material for cement industry kilns and use thereof

(76) Inventor: Pedro Farjardo Sola, Valencia (ES)

Correspondence Address: Law Offices of Albert Wai Kit Chan, Albert Wai Kit Chan, World Plaza Suite 604, 141 07 20th Avenue, Whitestone, NY, 11357, US

(21) Appl. No.: 10/470,527

(22) PCT Filed: Jan. 26, 2001
(86) PCT No.: PCT/ES01/00017

(51) Int. Cl. C04B 35/567; C04B 35/18

(52) U.S. Cl. 501/89; 501/128

(57) ABSTRACT

The invention relates to a refractory material for cement industry kilns and the use thereof. The inventive material can be used inside cement industry kilns in order to counteract the thermal and physico-chemical deformation that occurs inside the said kilns.

The invention composition is based on a combination of a percentage by weight equal to or greater than 10 of andalusite (Al₁₁SiO₄), a percentage by weight equal to or greater than 10 of silicon carbide (SiC) and a percentage by weight equal to or greater than 5 of clay. Moreover, kaolinite (Al₄[(OH)₈(SiO₄)₄]) can be used instead of andalusite in equal proportions.

The said refractory material can be used to line the inside of the cement kilns in the calcination areas (2), in the kiln outlet (6) and in the coolers (7).

### DESCRIPTION

The invention protected by this Patent is a refractory material for cement industry kilns and the use thereof.

This material can be used to line the inside of cement industry kilns or placed in particular areas of the kiln with a view to refractory capacity.

The cement industry is familiar with the use of refractory materials to line the interior of the kilns used to manufacture the said product in order to withstand the high working temperatures, which can reach around 1500 degrees Celsius in some areas, and the resulting physical and chemical reactions. However, the differing compositions of the refractory materials also lead to their having differing degrees of hardness and resistance to the deformation that is caused by the differences in kiln temperature in different parts of the same kiln, among other factors. This invention achieves a refractory material of greater hardness and resistance than the materials hitherto employed.

Various refractory materials are currently known and used but they all present drawbacks, both operative and functional, particularly as regards progressive deformation by high kiln temperatures, spalling and cracking. Consequently, the use of the materials developed to date always presents certain limitations compared to the invention described herein, as a result of its technical and cost advantages. Already known refractory materials are the addition of glass-manufacture crucibles, lime, silica, chromium, magnetite, aluminium oxide and aluminous silica glass (F:H: Norton, Refractarios, first Spanish edition published by Blume in 1972), as well as Japanese patents no. JP11230679 concerning variations in porosity of refractory bricks, no. JP11130485 as prefabricated panels or no. JP11201649 as glass textures; in relation to the arrangement of shapes of the materials the outstanding examples are European patent no. EP0911594 and the German patent DE19729582 concerning prefabricated bricks. All of these are prior to the invention described herein but are generic and imprecise compared to the same, and are often designed for the steel industry; in all these inventions the resulting chemical composition or form are either not applied to the peculiarities of the cement industry or are not detailed and not sufficiently established compared to that described herein.

These deficiencies are overcome by the chemical composition of this invention, a neo-silicate such as Andalucite (Al₁₁SiO₄), a crystalline solid such as silicon carbide (SiC) and a hydroaluminosilicate pelitic rock such as clay. This composition surpasses the above-mentioned limitations and increases the operational capacity and performance of the material, while its application presents certain features that significantly favour its use in cement industry kilns.

All the foregoing helps to achieve results as regards refractory quality, location within the kilns and resistance to alterations in shape wherever the invention is used (whether in geometrical configurations such as bricks or in formless configurations such as mortar) that already-known media do not provide.

The invention described herein combines certain chemical compounds for their physical properties: Andalusite (Al₁₁SiO₄) for its low porosity, low thermal conductivity and refractory capacity, silicon carbide (SiC) for its resistance to oxidation and abrasion, while also being highly refractory, and clay for its plasticity.

This three-part combination of solid crystalline compounds formed from silicon can be made up of different proportions by weight of each of its constituents in order to achieve a greater or lesser degree of thermal conductivity, according to the location and function of the refractory material in the different parts of the kiln.

In short, the result obtained by combining these components makes it possible to obtain a technical advantage with a product of greater hardness and greater resistance to the deformation caused by the heat inside cementproduction kilns and the physical and chemical reactions that occur within the said kilns. This leads to considerable cost advantages as the new invention reduces the number of kiln stoppage cycles for maintenance and replacing worn material in each work period. As well as these technical and cost improvements, it also results in a production process advantage for the most widely and frequently found kilns, those of the rotary type, as it achieves greater resistance and hardness in the materials arranged inside the kiln to assist the circulation of the cement clinker being processed such as retainers and areas with shapes or in the satellite coolers, with staggered forms and elliptical inlets, respectively, and is consequently more efficient in maintaining their design and function.

For a better understanding of the above-mentioned general characteristics, drawings are attached hereto showing the following:

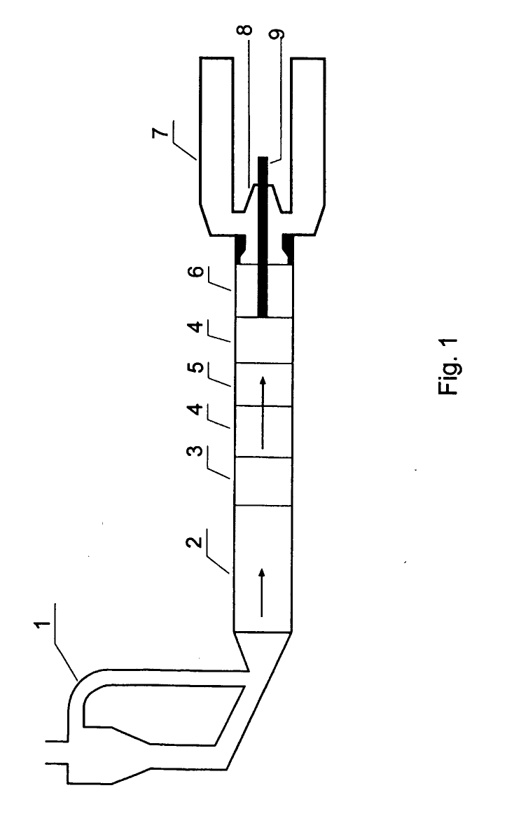

FIG. 1: Outline drawing of a rotary kiln with satellite coolers for the cement industry, in a configuration comprising a heat exchanger (1) and a calcination area (2), safety area (3), transition area (4), sintering area (5), outlet area (6), coolers (7), kiln head (8) and flame burner (9).

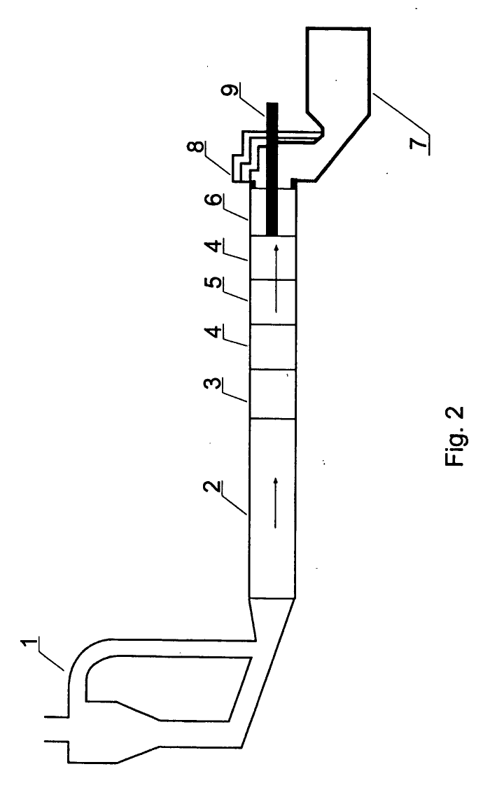

FIG. 2: Outline drawing of a rotary kiln with grate coolers for the cement industry, in a configuration comprising a heat exchanger (1) and a calcination area (2), safety area (3), transition area (4), sintering area (5), outlet area (6), coolers (7), kiln head (8) and flame burner (9).

The refractory material can be made up and placed as follows:

As regards the chemical components, a percentage by weight of andalusite (Al₁₁SiO₄) of 10-80%, a percentage by weight of silicon carbide (SiC) of 10-80% and a percentage by weight of clay of 10-15%.

The preferable average composition is in the following proportions:

| | Percentage by weight |
|---|---|
| Andalusite (Al₁₁SiO4): | 55% |
| Silicon carbide (SiC): | 35% |
| Clay: | 10% |

Given its cost advantages, kaolinite (Al₄[(OH)₈(SiO₄)₄]) can also be used instead of andalusite, in equal proportions.

As regards its location in the kilns, the areas where this refractory material is used are: the calcination area (2), the safety area (3), the transition area (4), the kiln outlet (6) and the coolers (7).

1. Refractory material for cement industry kilns and its use for resistance to thermal, physical and chemical deformation, characterised by a chemical composition that combines a percentage by weight equal to or greater than 10 of andalusite (Al₁₁SiO₄), a percentage by weight equal to or greater than 10 of silicon carbide (SiC) and a percentage by weight equal to or greater than 5 of clay.

2. Use of the refractory material as claimed under claim 1, characterised by the use thereof to line the inside of cement industry kilns in the calcination areas (2), in the safety area (3), in the outlet area (6) and in the coolers (7).

3. Refractory material for cement industry kilns and its use for resistance to thermal, physical and chemical deformation, characterised by a chemical composition that combines a percentage by weight equal to or greater than 10 of kaolinite (Al₄[(OH)₈(SiO₄)₄]), a percentage by weight equal to or greater than 10 of silicon carbide (SiC) and a percentage by weight equal to or greater than 5 of clay.
